(19) United States
(12) Patent Application Publication
(10) Pub. No.: US 2026/0311113 A1
(43) Pub. Date: Oct. 8, 2026

(54) RFID SYSTEMS FOR MONITORING PARCELS

(71) Applicant: Federal Express Corporation, Memphis, TN (US)

(72) Inventors: Phillip Pettit, Germantown, TN (US); Josh Hohman, Memphis, TN (US); Dennis Harner, Harrison, AR (US); Anthony Hyatt, Harrison, AR (US)

(73) Assignee: Federal Express Corporation, Memphis, TN (US)

(21) Appl. No.: 19/098,077

(22) Filed: Apr. 2, 2025

(51) Int. Cl. G06Q 10/087; G06K 7/10; G06K 19/07; G06Q 10/0833

(52) U.S. Cl. CPC G06Q 10/087; G06K 7/10356; G06K 7/10425; G06K 19/0723; G06Q 10/0833

(57) ABSTRACT

Systems, methods, and non-transitory computer-readable media with instructions for monitoring parcels in a shipping facility using Radio Frequency Identification (RFID) are disclosed. In one embodiment, an RFID system is provided, which includes a sensor to capture dimension measurements of parcels moved by a vehicle. The RFID system also features an RFID reader configured to retrieve shipment information from the RFID tags of parcels. Additionally, the system includes a processor that receives dimension measurements of a parcel from the sensor and signals from the parcel's RFID tag via the RFID reader. The processor processes these signals to determine shipment information while the parcel is within the area covered by both the sensor and the RFID reader. It then updates an inventory management system with data associating the shipment information with the parcel's dimension measurements. This integration aims to streamline operations and improve the efficiency of the shipping facility.

### TECHNICAL FIELD

The present disclosure generally relates to systems and methods for monitoring parcels in shipping facilities. More particularly, the present disclosure relates to Radio Frequency Identification )RFID) systems and methods for monitoring parcels being moved by vehicles in shipping facilities.

### BACKGROUND

In the logistics and shipment industries, accurately measuring palletized goods is essential for optimizing space utilization, determining shipping costs, and ensuring compliance with carrier regulations. Traditionally, pallet dimensioning has been performed manually, a process prone to human error that often leads to revenue loss due to underreported dimensions or incorrect freight classifications. Over time, automated dimensioning solutions have been developed to improve efficiency by enabling real-time measurement of palletized goods in motion.

However, today's automated dimensioning systems still rely on barcodes to identify shipment information, which presents significant reliability issues. Barcodes can become damaged, obscured, or go missing. This can cause delays, errors in package identification, and potential revenue loss. As global supply chains become more complex and demand for expedited shipping increases, there is a growing need for a more efficient and reliable method of dimensioning and identifying palletized parcels without relying solely on barcodes.

Given the increasing demand for automation and efficiency in parcel handling, there is a strong need to meet the evolving requirements of the logistics industry. The disclosed solutions provide improvements to Radio Frequency Identification (RFID) technology and incorporate it to automated dimensioning systems to enable updating inventory management system in real time.

### SUMMARY

Some disclosed embodiments may include systems, methods and non-transitory computer readable media for monitoring parcels in shipping facilities using Radio Frequency Identification (RFID). These embodiments may involve receiving, from at least one sensor with a first field of view defining a first capturing area, a set of dimension-measurements of a first parcel while the first parcel is moved by a vehicle through the first capturing area; receiving, from at least one RFID reader associated with a second field of view defining a second capturing area that at least partially overlaps with the first capturing area and thereby forms an overlapping area, signals from a first RFID tag of the first parcel and from a group of RFID tags of parcels located outside the overlapping area; controlling operations of the at least one RFID reader to limit interference from the group of RFID tags; processing the signals from a first RFID tag to determine first shipment information while the first parcel is located in the overlapping area; making a determination that the first shipment information correlates with the set of dimension-measurements of the first parcel; and in response to the determination, updating an inventory management system with data associating the first shipment information with the set of dimension-measurements of the first parcel.

The foregoing general description and the following detailed description are exemplary and explanatory only and are not restrictive of the claims.

### BRIEF DESCRIPTION OF THE DRAWINGS

FIG. 1 is a side-view illustration of an exemplary RFID system in a shipping facility, consistent with embodiments of the present disclosure.

FIG. 2 is a top-view illustration of the exemplary RFID system of FIG. 1, consistent with embodiments of the present disclosure.

FIG. 3 is a side-view illustration of an exemplary RFID reader configuration, consistent with embodiments of the present disclosure.

FIG. 4 is a flowchart illustrating an exemplary method for monitoring parcels in a shipping facility, consistent with disclosed embodiments.

### DETAILED DESCRIPTION

It will be appreciated that the embodiments of the present disclosure are not limited to the exact construction described below and illustrated in the accompanying drawings, and that various modifications and changes may be made without departing from the scope thereof. And other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

Various terms used in the specification and claims may be defined or summarized differently when discussed in connection with different disclosed embodiments. It is to be understood that the definitions, summaries and explanations of terminology in each instance apply to all instances, even when not repeated, unless the transitive definition, explanation, or summary would result in inoperability of an embodiment. It is also to be understood that once a term is defined herein, in the absence of an inherent inconsistency, that definition applies to all other uses of the term herein. Moreover, the exemplary embodiments of the figures and their description are not to be considered definitions of claim terms, but rather are non-limiting examples used to illustrate specific embodiments.

Throughout, this disclosure mentions “embodiments” and “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. This disclosure employs open-ended permissive language, indicating for example, that some embodiments “may” employ, involve, or include specific features. The use of the term “may,” and other open-ended terminology, is intended to indicate that although not every embodiment may employ the specific disclosed feature, at least one embodiment employs the specific disclosed feature.

In the following specification, embodiments are described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as examples only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In one aspect of the disclosure, methods, systems, and software are provided for monitoring parcels in a shipping facility using Radio Frequency Identification (RFID). The term “parcel” refers to a discrete physical item or multiple items grouped together for shipping, delivery, or transportation from one location to another. A parcel typically comprises one or more objects contained within or constituting an outer packaging material such as cardboard, plastic, paper, or other protective wrapping. Parcels may vary in size, shape, weight, and contents, and may encompasses various types of shipped items including but not limited to boxes, containers, crates, envelopes, and padded mailers. In some embodiments, a pallet may constitute a parcel when it serves as a shipping platform for one or more items secured together for transportation purposes. The term ““monitoring parcels” refers to the process of tracking, observing, or gather information about parcels, such as their status, location, or condition. This may include scanning a code (e.g., barcode or QR-code) associated with the parcel or communicate with an RFID tag attached to the parcel. For example, monitoring parcels might involve using tracking technologies to follow the progress of delivery packages from sender to recipient. The term “shipping facility” refers to a location or establishment where parcels are processed for shipment, which may include activities such as sorting, packaging, and dispatching. Examples of shipping facilities include warehouses, distribution centers, and postal service centers.

In shipping facilities, there are numerous RFID tags and interference can become a significant issue that hinders the ability of an RFID reader to communicate effectively with a specific tag. This interference arises when multiple tags attempt to respond simultaneously to a reader's query, causing signal collisions that make it challenging to isolate and interpret responses from individual tags. This interference can also distort the electromagnetic field generated by the RFID reader, adversely affecting the power and signal quality received by the target tag. The following disclosure presents below innovative techniques designed to mitigate such interference and enhance communication with specific RFID tags in a measurement area. Moreover, the presence of signals from numerous non-relevant tags poses a significant challenge to accurately determining shipment information. The RFID reader often pick up readings from both moving and static RFID tags located outside the measurement area. This influx of irrelevant data can lead to inefficiencies and inaccuracies in the system's performance. The following disclosure presents below advanced techniques to filter out these non-relevant signals, thereby enhancing the system's accuracy. In addition, the proposed system address the challenge of accurately and efficiently associating shipment information with dimension measurements during parcel handling processes. Traditional methods may struggle with inaccuracies and slow processing speeds, particularly when dealing with large volumes of shipments or when multiple parcels are moved simultaneously. To address this challenge, the following disclosure presents below integration of Artificial Intelligence (AI) and Machine Learning (ML) to refine the detection of RFID tags associated with dimension capture events and to eliminate extraneous data and identifying simultaneous parcel movements, thereby streamlining the sorting and handling processes.

While the embodiments described herein primarily utilize RFID (Radio Frequency Identification) technology, it should be understood that the inventive process is not limited to this specific implementation. Alternative existing technologies such as NFC (Near Field Communication), Bluetooth Low Energy (BLE), or ultrasonic identification may be substituted without departing from the scope of the invention. Furthermore, this disclosure contemplates the application of identification technologies that may be developed in the future provided they can perform the fundamental functions described herein. The selection of appropriate technology may be based on considerations including type of shipping facility, types of stored parcels, range requirements, power consumption, security needs, environmental conditions, compatibility with existing system, and more.

The present disclosure address the above problems in a manner that increase the productivity of the shipping facility. The term “increasing productivity” refers to enhancing the efficiency and effectiveness of operations within a shipping facility, through improved processes, reduced time, or optimized resource utilization. For example, increasing productivity may involve streamlining parcel tracking and handling processes to reduce delays and errors. Consistent with the present disclosure, increasing the productivity of the shipping facility may be achieved through advanced technological improvements. For example, incorporating the suggested RFID technology may reduce the number of scans and/or reduce the time it takes for the system to recognize the parcels. Thereby, lowering processor utilization and minimize delays and errors. While the embodiments described herein primarily utilize RFID (Radio Frequency Identification) technology, it should be understood that the inventive process is not limited to this specific implementation. Alternative existing technologies such as NFC (Near Field Communication), Bluetooth Low Energy (BLE), or ultrasonic identification may be substituted without departing from the scope of the invention. Furthermore, this disclosure contemplates the application of identification technologies that may be developed in the future provided they can perform the fundamental functions described herein. The selection of appropriate technology may be based on considerations including type of shipping facility, types of stored parcels, range requirements, power consumption, security needs, environmental conditions, compatibility with existing system, and more.

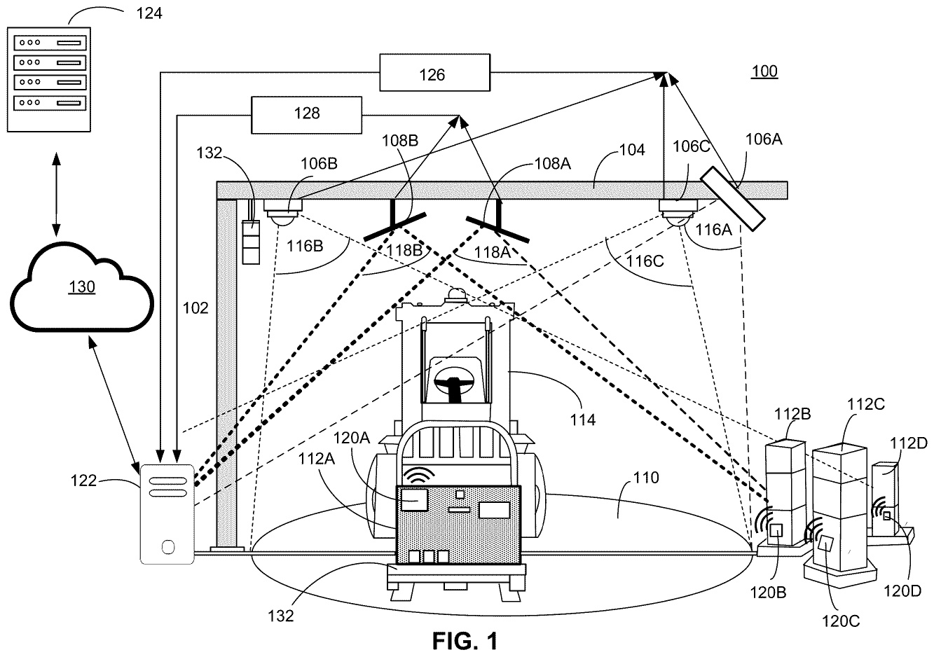

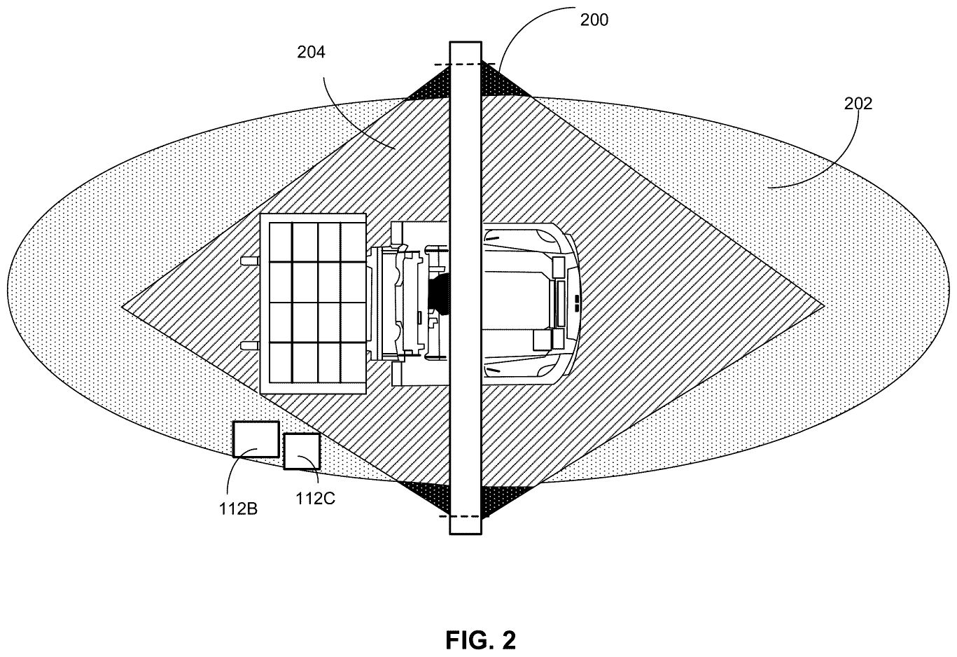

FIGS. 1 and 2 are schematic illustrations of an example RFID system 100 monitoring parcels in a shipping facility, consistent with some embodiments of the present disclosure. RFID is a wireless communication technology that uses radio frequency signals to identify and track objects. An RFID system typically includes at least one RFID tag (comprising an integrated circuit and an antenna), an RFID reader, and a backend system for processing data. The RFID tag may be passive, active, or semi-passive, and it transmits stored information to the RFID reader when in proximity. The reader captures the data and communicates it to a computing system for authentication, tracking, or other processing purposes.

RFID system 100 may include a base structure 102 connected to a crossbeam 104 for positioning sensor 106 (e.g., sensor 106A, sensor 106B, and sensor 106C) and RFID reader 108 (e.g., RFID reader 108A, RFID reader 108B) above a measurement area 110. For simplicity, any element in the figures that includes a suffix such as “A,” “B,” or “C” may be referred to collectively without the suffix. Unless stated otherwise, such references encompass each instance of the element individually or all instances collectively. The term “sensor” refers to any type of device or apparatus that detects or measures a physical property and records, indicates, or otherwise responds to it. For example, a sensor may include a camera, laser scanner, or ultrasonic device used to measure dimensions of parcels. Sensor 106 may be associated with a first field of view 116, defining a first capturing area (e.g., first capturing area 200 illustrated in FIG. 2). Sensor 106 of RFID system 100 may be configured to capture one or more dimension-measurements 126 of parcels 112 placed on a pallet 132 and being moved by a vehicle 114 through measurement area 110 associated with the first field of view 116. In some embodiments, sensor 106 may include any number of a LIDAR sensor, an infrared sensor, an ultrasonic sensor, or a camera-based sensor. For example, RFID system 100 may include a LIDAR sensor 106A associated with first field of view 116A, configured to scan the top surface of a parcel, determining its height by measuring the distance from the sensor to various points on the parcel. The LIDAR sensor may emit laser pulses, and the system calculates height based on the time delay between emission and reflection. RFID system 100 may also include two camera-based sensors 106B and 106C positioned on opposite sides of crossbeam 104 and associated with first fields of view 116B and 116C. Camera-based sensors 106B and 106C may be configured to capture the width and depth of the palletized load. These camera-based sensors may use stereo vision to generate a three-dimensional point cloud of the parcel's external boundaries. To improve accuracy, RFID system 100 may integrate an alignment detection module, which includes infrared or ultrasonic sensors to detect whether the parcel is correctly positioned within the measurement area and trigger alerts if realignment is necessary. All data captured by sensor 106 may be processed to determine a set of dimension-measurements of parcel 112. In one implementation, the set of dimension-measurements may include height, width, and depth.

In some embodiments, RFID system 100 may include a weight sensor configured to measure the weight of the first parcel. For example, the weight sensor may be located beneath a platform in the measurement area. This weight sensor includes load cells capable of capturing the total weight of vehicle 114 and a first parcel 112A being moved by vehicle 114. The weight data may be synchronized with the dimensional measurements to provide a complete set of dimension-measurements that includes height, width, depth, and mass weight of the first parcel 112A. Thereafter, the RFID system may update an inventory management system (as explained below in detail) with the weight of the first parcel.

Consistent with the present disclosure, RFID system 100 may include RFID reader 108 with a second field of view 118, defining a second capturing area (e.g., second capturing area 202 illustrated in FIG. 2) that at least partially overlaps with the first capturing area and thereby forms an overlapping area (e.g., overlapping area 204 illustrated in FIG. 2). The term “RFID reader” refers to a device that emits radio waves and receives signals from RFID tags to read data stored on them. For example, an RFID reader might be used to scan tags attached to parcels to identify the parcels. In some embodiments, RFID reader 108 may use wireless, non-contact radio-frequency electromagnetic fields to transfer signals 128 for the purpose of automatically detecting shipment information from parcels 112 with attached RFID tags 120. The frequency of an RFID reader 108 depends on the type of RFID tags used for parcels 112. For example, RFID reader 108 may operate using 13.56 MHz (known as high frequency range), may operate using 860-960 MHz (known as ultra-high frequency range), or may operate using other frequency ranges suitable for RFID communication. RFID reader 108 may periodically emit interrogation signals at configurable power levels (e.g., between 0.5 W to 2 W) in an area surrounding RFID reader 108. Currently, the typical data rates of RFID systems are between 40 -640 kbps, but these rates are expected to increase over time as technology advances. In the context of the present disclosure, RFID reader 108 is configured to retrieve shipment information (e.g., Electronic Product Code) from RFID tags 120 of parcels 112 in measurement area 110.

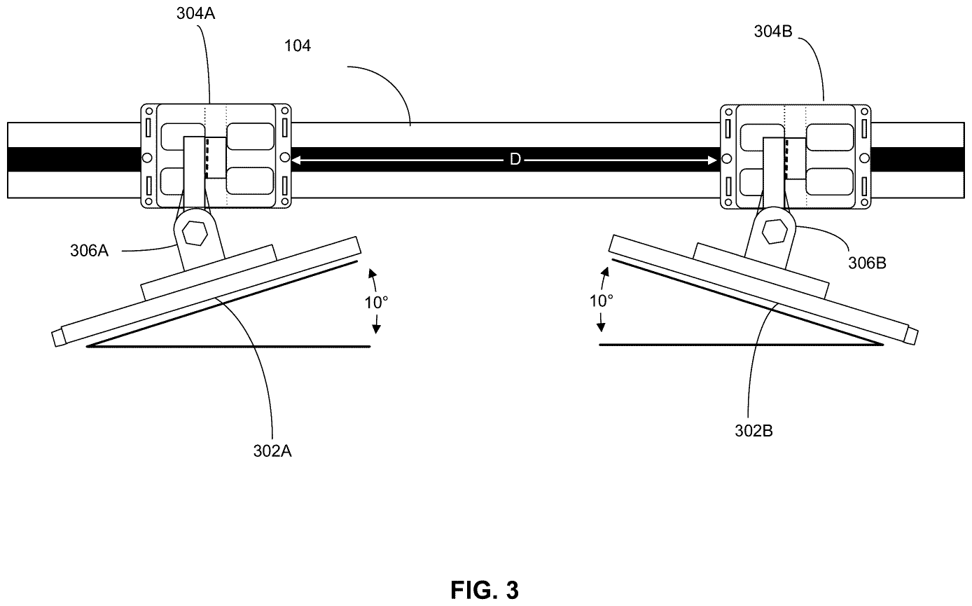

In some embodiments, RFID reader 108 may include a plurality of antenna arrays separated from each other. The use of a plurality of antenna arrays is designed to enhance the performance and capabilities of RFID reader 108, such as read range, directionality, and interference rejection. In some cases, the plurality of antenna arrays may include two individual antennas arranged in a specific geometric pattern, such as a linear or two-dimensional configuration. The antenna arrays work by leveraging the principles of constructive and destructive interference of electromagnetic waves. By carefully controlling the phase and amplitude of signals fed to each antenna element in the array, the system can manipulate the overall radiation pattern. This allows for beam forming and steering, where the array can focus its energy in specific directions or shape the beam to cover desired areas more effectively, thereby allowing RFID readers to focus on particular areas or tags while minimizing interference from unwanted sources. In some embodiments, a distance between two opposing antenna arrays from the plurality of antennas arrays is greater than 0.5 meter. An example configuration for positioning antenna arrays is described below with reference to FIG. 3. By using a plurality of antenna arrays, RFID reader 108 may create an electromagnetic field with a read range of 1-10 meters, depending on environmental conditions and tag sensitivity.

In disclosed embodiments, RFID reader 108 may be configured to decode the shipment information from a passive RFID tag. Passive RFID tags do not have an internal power source. They are powered by the electromagnetic energy transmitted from an RFID reader. Passive RFID tags typically have a read range of 1-10 meters and may be powered entirely by the RF signals from RFID reader 108 through inductive coupling or backscatter coupling techniques. In alternative embodiments, at least one RFID reader may be configured to decode the shipment information from a semi-passive tag. Semi-passive tags include a power source to power internal circuits and memory storage but still rely on RFID reader 108′s electromagnetic field to supply power for communications. In further alternative embodiments, at least one RFID reader may be configured to decode the shipment information from an active tag. Active tags contain a battery that powers all circuitry and communications, enabling longer read ranges of up to 100 meters and supporting onboard sensors.

RFID system 100 may also include at least one processor 122, which may include any physical device or group of devices having electric circuitry that performs a logic operation on an input or on inputs. For example, at least one processor may include one or more integrated circuits (IC), including application-specific integrated circuit (ASIC) microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller, or may be stored in a separate memory. The term “memory,” as used in this disclosure, may include a Random Access Memory (RAM), a Read-Only Memory (ROM), a hard disk, an optical disk, a magnetic medium, a flash memory, other permanent fixed or volatile memory, or any other mechanism capable of storing instructions. Memory may include one or more separate storage devices, collocated or dispersed, capable of storing data structures, instructions, or any other data. Memory may further include a memory portion containing instructions for the processor to execute. The memory may also be used as a working scratch pad for the processors or as temporary storage.

In some embodiments, at least one processor may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively and may be co-located or located remotely from each other. The processors may be coupled electrically, magnetically, optically, acoustically, mechanically, or by other means that permit them to interact. In one embodiment, the operations of the at least one processor may be executed using a first processor associated with sensor 106 and/or using a second processor associated with RFID reader 108. Additionally or alternatively, a first part of the operations of the at least one processor may be executed using a first processor associated with sensor 106 while a second part of the operations may be executed using a second processor associated with RFID reader 108.

In some embodiments, at least one processor 122 may receive from sensor 106 a set of dimension-measurements of a first parcel 112A while first parcel 112A is located in the first capturing area 200. The set of dimension-measurements may include at least one of height, width, and depth of first parcel 112A. At least one processor 122 may also receive from RFID reader 108 signals from a first RFID tag 120A of first parcel 112A and from a group of RFID tags 120B, 120C, and 120D of parcels 112B, 112C, and 112D located in the second capturing area 202 and outside the overlapping area 204. For simplicity, in the following discussion, it is assumed that measurement area 110 corresponds with overlapping area 204 illustrated in FIG. 2.

When multiple RFID tags 120 are located in the second capturing area 202 of RFID reader 108, they can create interference that impacts the RFID reader's ability to communicate with a specific tag (e.g., first RFID tag 120A of first parcel 112A). This interference may occur when the other RFID tags (e.g., RFID tags 120B, 120C, and 120D) attempt to simultaneously respond to a query from RFID reader 108. When this happens, the signals from all the RFID tags can collide, making it difficult for the reader to isolate and interpret the response from the specific tag. Additionally, the presence of multiple RFID tags can distort the electromagnetic field generated by RFID reader 108, affecting the power and signal quality received by the specific tag.

Consistent with the present disclosure, RFID system 100 may control operations of RFID reader 108 to limit interference from the group of RFID tags (e.g., RFID tags 120B, 120C, and 102D). Specifically, RFID reader 108 may employ several techniques to mitigate interference and improve communication with specific tags. In one example, RFID system 100 may instruct RFID reader 108 to assign time slots to tags, thus allowing them to respond in sequence rather than simultaneously. Additionally or alternatively, RFID system 100 may instruct RFID reader 108 to systematically query tags with specific ID prefixes, effectively partitioning the tag population to isolate individual tags. Additionally or alternatively, RFID system 100 may operate RFID reader 108 at a reduced power level to limit its read range to areas in the shipping facility beyond the first capturing area. Additionally or alternatively, RFID system 100 may reduce the transmission power of RFID reader 108 to limit the number of tags that respond, focusing on one or more tags closest to RFID reader 108. Additionally or alternatively, RFID system 100 may operate RFID reader 108 in a manner that modulates its power output based on dimensions of measurement area 110. Additionally or alternatively, RFID system 100 may select transmission frequencies according to predetermined patterns to minimize consistent interference at any specific frequency. Additionally or alternatively, RFID system 100 may use antenna arrays for RFID reader 108 with narrower radiation patterns to focus energy toward specific locations associated with measurement area 110. Additionally or alternatively, RFID system 100 may position the antenna arrays for RFID reader 108 in a manner that creates spatial diversity and improves signal reception from specific directions associated with measurement area 110. Additionally or alternatively, RFID system 100 may use protocol-specific commands to prevent stationary RFID tags from responding to subsequent read cycles.

In some embodiments, at least one processor 122 may process signals 128 received from first RFID tag 120A to determine first shipment information while first parcel 112A is located in measurement area 110. The shipment information determined from the signals from first RFID tag 120A may include a Unique Identifier (UID) that can be used to track individual items within a shipment, product information such as SKU numbers, product names, or batch numbers, and a timestamp to record when first RFID tag 120A was read. In some cases, pallet 132 may support more than one parcel 112 each with its own individual RFID tag 120. In these cases, at least one processor 122 may distinguish between the parcels on pallet 132 using the shipment information determined from the signals from each corresponding RFID tag. Moreover, advanced passive RFID tags may include sensors to monitor environmental conditions such as temperature or humidity, which is particularly useful for shipments of perishable goods or sensitive electronics. In these cases, the shipment information may include data from the sensors.

At least one processor 122 may also determine that the first shipment information corresponds to the set of dimension measurements of first parcel 112A. The determination that the first shipment information correlates with the set of dimension measurements of the first parcel involves determining that an RFID tag (e.g., RFID tag 120A) corresponding with the first shipment information recently entered into the second capturing area (i.e., measurement area 110). Essentially, when both the dimension measurements and the shipment information are received during the same time frame from an object within the measurement area, it indicates that the set of dimension measurements and the shipment information are linked to the same parcel. For example, consider a parcel with an RFID tag 120. As it moves into the measurement area, sensor 106 captures its dimensions: length, width, and height. At the same time frame, RFID reader 108 detects the RFID tag 120 and retrieves the associated shipment information. At least one processor 122 then checks if the timestamp of the dimension measurements aligns with the timestamp of the RFID tag reading. If both data sets are captured within the same time frame (e.g., 1 second, 5 seconds, 20 seconds, less than 100 seconds), the processor may conclude that the set of dimension measurements and the shipment information correspond to the same parcel.

Some embodiments involve outputting an error message when multiple RFID tags are detected in the overlapping area simultaneously. The term outputting may include sending, transmitting, generating, displaying, or otherwise causing information to be presented. The term error message refers to information conveyed to indicate an unexpected condition, malfunction, or prohibited action within a system or device. In some cases, the error message may be provided as a Graphical User Interface (GUI) element on a display of a computing device associated with a driver of vehicle 114 (e.g., a control system of vehicle 114). Additionally or alternatively, the error message may be provided as an audio indication, such as distinctive sound patterns or alert tones. In one embodiment, a traffic signal apparatus 132 may serve as an error message output device. The traffic signal, typically comprising red, yellow, and green lights, can convey error messages as follows: Solid Red Light may indicate that multiple RFID tags are detected in the overlapping area simultaneously. Solid Green Light may indicate that a single RFID tag was identified, and the shipment information was successfully determined. Blinking Yellow Light may indicate that a single RFID tag was identified, but the shipment information was not yet determined.

In response to the determination, at least one processor 122 may update an inventory management system 124 with data associating the first shipment information with the set of dimension measurements of the first parcel 112A. In some embodiments, updating inventory management system 124 may involve accessing a data structure. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database, or NoSQL alternatives for data storage/search such as, for example, MongoDB, Redis, Couchbase, Datastax Enterprise, Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers; for example, a data structure may be owned or operated by the same or different entities. Thus, the term data structure, as used herein in the singular, is inclusive of plural data structures.

In one embodiment, the inventory management system is being updated while the first parcel is being moved by the vehicle. In other words, the inventory management system may be updated substantially in real time. Updating inventory management system 124 in substantially real-time may involve a network 130 for connecting RFID system 100 with the inventory management system 124. In the context of this disclosure, a network may include any type of physical or wireless computer networking arrangement used to exchange data. For example, a network may be the Internet, a private data network, a virtual private network using a public network, a Wi-Fi network, a LAN or WAN network, a combination of one or more of the foregoing, and/or other suitable connections that may enable information exchange among various components of the system. In some embodiments, a network may include one or more physical links used to exchange data, such as Ethernet, coaxial cables, twisted pair cables, fiber optics, or any other suitable physical medium for exchanging data. A network may also include a public switched telephone network (PSTN) and/or a wireless cellular network. A network may be a secured network or an unsecured network. In other embodiments, one or more components of the system may communicate directly through a dedicated communication network. Direct communications may use any suitable technologies, including, for example, BLUETOOTH, BLUETOOTH LE (BLE), Wi-Fi, near-field communications (NFC), or other suitable communication methods that provide a medium for exchanging data and/or information between separate entities.

FIG. 3 illustrates an adjustable mounting assembly 300 adapted for supporting and orienting two antenna arrays 302A and 302B of RFID reader 108 on crossbeam 104. The adjustable mounting assembly comprises two mounting brackets 304A and 304B slidably engageable with crossbeam 104. The mounting brackets incorporate a mechanism, such as a rack and pinion or similar geared arrangement, to allow for precise positional adjustments along crossbeam 104. Thereby enabling the user to customize the lateral distance D between the two RFID antenna arrays 302 for optimizing coverage and/or minimizing interference. In some embodiments, the distance between the two mounting brackets 306 may be between 0.25 m to 1.5 m, greater than 0.5 m, or less than 2 m. The distance can be adjusted to accommodate different sizes and configurations of RFID reader 108.

Adjustable mounting assembly 300 may also include tilting platforms 308A and 306B specifically designed to interface with RFID antenna arrays. Tilting platforms 306A and 306B are pivotally attached to mounting brackets 304A and 304B, respectively, allowing for angular adjustments of antenna arrays 302A and 302B relative to the horizontal plane. In one embodiment, antenna arrays 302A and 302B may be positioned at a tilt angle between 5 degrees and 25 degrees (e.g., 10 degrees). However, tilting platforms 306A and 306B enable users to fine-tune the tilting angles of antenna arrays 302A and 302B to optimize signal direction and read range. In one implementation, a distance between two opposing arrays 302A and 302B is greater than 0.5 meter and an angle at which the two opposing antenna arrays intersect is 160 degrees.

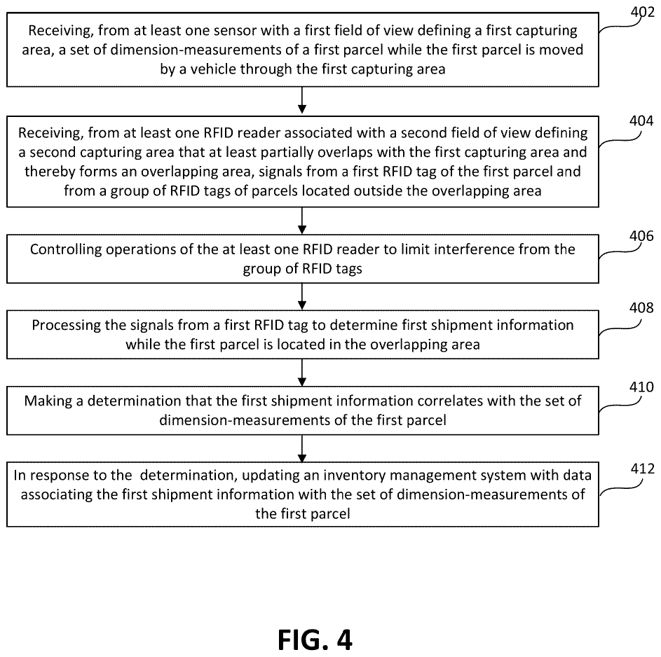

FIG. 4 illustrates a flowchart of an exemplary process 400 for monitoring parcels in a shipping facility using RFID, consistent with embodiments of the present disclosure. In some disclosed embodiments, process 400 may be performed by at least one processor associated with RFID system 100 (e.g., at least one processor 122, or inventory management system 124) to perform operations or functions described herein. In some embodiments, some aspects of process 400 may be implemented as software (e.g., program codes or instructions) that are stored in a memory or a non-transitory computer-readable medium. In some embodiments, some aspects of process 400 may be implemented as hardware (e.g., a specific-purpose circuit). According to other embodiments, process 400 may be implemented as a combination of software and hardware.

Specifically, some embodiments involve a non-transitory computer-readable medium containing instructions that, when executed by at least one processor, cause the at least one processor to perform operations for executing process 400. The term “non-transitory computer-readable medium” may include any medium capable of storing data in any memory in a way that may be read by any computing device with a processor to carry out methods or any other instructions stored in the memory. The non-transitory computer-readable medium may be implemented as hardware, firmware, software, or any combination thereof. Moreover, the software may preferably be implemented as an application program tangibly embodied on a program storage unit or computer-readable medium consisting of parts, or of certain devices or a combination of devices. The application program may be uploaded to, and executed by, a machine having any suitable architecture. The machine may be implemented on a computer platform having hardware such as one or more central processing units (“CPUs”), a memory, and input/output interfaces. The computer platform may also include an operating system and microinstruction code. The various processes and functions described in this disclosure may be either part of the microinstruction code or part of the application program or any combination thereof which may be executed by a CPU, whether or not such a computer or processor is explicitly described. In addition, various other peripheral units may be connected to the computer platform, such as an additional data storage unit and a printing unit. Furthermore, a non-transitory computer-readable medium may be any computer-readable medium except for a transitory propagating signal.

Step 402 of process 400 includes receiving from at least one sensor with a first field of view defining a first capturing area a set of dimension-measurements of a first parcel while the first parcel is moved by a vehicle through the first capturing area. In the context of this disclosure, the term “receiving” may include retrieving, acquiring, or otherwise gaining access to data. For example, receiving may include reading data from memory and/or acquiring data from a sensor or an associated computing device via a wired or a wireless communications channel. The term “field of view” refers to a portion of the environment that a sensor can monitor or observe. For an optical sensor, the field of view defines the spatial region within which the sensor can detect visual data. For an RFID reader, the field of view refers to the coverage area within which the reader can detect and communicate with RFID tags. The term “a capturing area” refers to a spatial region within which measurements or signals are observed. For example, a capturing area may be a zone where parcels are scanned as they pass by a sensor. The term “a set of dimension-measurements” refers to a collection of data points that describe the physical properties of an object. For example, dimension-measurements may include length, width, and height of a parcel. The term “a vehicle” refers to any means of conveyance or transport used to move goods or parcels. For example, a vehicle might be a conveyor belt, forklift, or automated guided vehicle (AGV). By way of example and with reference to FIGS. 1 and 2, step 402 may involve receiving from sensor 106A with first field of view 116A, which defines first capturing area 200, a set of dimension measurements of first parcel 112A while first parcel 112A placed on pallet 132 is moved by vehicle 114 through first capturing area 200.

Step 404 of process 400 includes receiving from at least one RFID reader associated with a second field of view defining a second capturing area that at least partially overlaps with the first capturing area and thereby forms an overlapping area signals from a first RFID tag of the first parcel and from a group of RFID tags of parcels located outside the overlapping area. In the context of this disclosure, the term “signals from a RFID tag” refers to the radio frequency transmissions emitted by an RFID tag that convey data to an RFID reader. For example, the signals from a RFID tag might include a unique identifier for the parcel. The term “at least partially overlaps” refers to the condition where two areas share a common region. For example, the second capturing area might intersect with the first capturing area, thus creating a shared space. By way of example and with reference to FIGS. 1 and 2, step 404 may involve receiving from RFID reader 108 signals from first RFID tag 120A of first parcel 112A and from a group of RFID tags 120B, 120C, and 120D of parcels 112A, 112C, and 112D located outside measurement area 110. RFID reader 108 may be associated with second field of view 118A defining second capturing area 202 that at least partially overlaps with first capturing area 200 and thereby forms overlapping area 204. As discussed above, measurement area 110 illustrated in FIG. 1 is considered to correspond with overlapping area 204 illustrated in FIG. 2.

Some disclosed embodiments involve filtering out readings from RFID tags to improve the accuracy and the efficiency of the RFID system. Specifically, this involves filtering out readings from moving RFID tags located outside the overlapping area and/or filtering out readings from static RFID tags located in the overlapping area. The term “filtering out” refers to the process of selectively removing or ignoring certain data or signals. This process aims to increase the likelihood of successfully determining shipment information from RFID tags located in the measurement area. In some instances, the filtering may be performed by signal processing techniques like threshold-based filtering that ignores signals below a certain strength level, time-domain filtering that only processes signals during specific time windows, or spatial filtering using directional antennas to focus on signals from particular locations. In other instances, the filtering may be performed by machine learning approaches that can analyze signal patterns to distinguish between relevant and non-relevant tags based on historical data, adaptive filtering that learns and adjusts filtering parameters over time based on, for example, detected movements, or anomaly detection to identify and filter out unusual or unexpected tag behaviors. In other instances, the filtering may be performed by protocol-based filtering methods including selective querying that only requests responses from tags with specific identifiers or attributes, session-based filtering that tracks which tags have already been processed, and/or implementing anti-collision protocols that selectively communicate with tags based on their priority or relevance. In the first embodiment, RFID system 100 may filter out readings from at least one moving RFID tag located outside the overlapping area. The rationale for filtering these readings is that if the tag is not located inside the measurement area, it is most likely not related to the parcel being measured by sensor 106. In the second embodiment, RFID system 100 may filter out readings from at least one static RFID tag located within the overlapping area. The rationale for filtering these readings is that if the tag remains static for a period longer than a predetermined threshold, it is likely not related to the parcel being moved by a vehicle through the measurement area.

Step 406 of process 400 includes controlling operations of the at least one RFID reader to limit interference from the group of RFID tags. The term “controlling operations” refers to managing or directing the functioning, configuration, activities, or physical arrangement of the at least one RFID reader. In some cases, controlling the operation involves a processing device regulating the operation of the RFID reader. For example, modifying the transmission power to reduce reading range and avoid detecting unwanted tags, implementing frequency-hopping spread spectrum techniques to cycle through different channels, or scheduling read operations in a staggered pattern to prevent multiple readers from transmitting simultaneously. In other cases, controlling the operation includes adjusting RF antenna settings or physically positioning antennas to minimize unwanted signal interference. For example, physically orienting or relocating antennas to focus the RF field on specific tag areas, strategically placing RF-blocking materials around antennas to constrain the reading field, configuring antenna polarization to match tag orientation while minimizing crosstalk, or using directional antennas with specific beam patterns to focus RF energy where needed. The term “limit interference” refers to reducing or minimizing the disruption or obstruction of signals or operations. By way of example and with reference to FIGS. 1 and 2, step 406 may involve limiting interference to reduce the effect of RFID tags 120A, 120B, and 120C.

Step 408 of process 400 includes processing the signals from a first RFID tag to determine first shipment information while the first parcel is located in the overlapping area. The term “processing” refers to performing operations or calculations on data to extract information or achieve a desired result. For example, processing might involve analyzing signals from a specific RFID tag to derive information about a parcel associated with the specific RFID tag. The term “signals” refers to any form of data or information conveyed through a medium, such as radio waves. For example, the signals might include encoded data from RFID tags. The term “determine” refers to establishing or ascertaining information through analysis or calculation. For example, determining might involve identifying shipment information of a parcel based on RFID data. The term “shipment information” refers to data related to the transport or delivery of goods. In one example, the shipment information may include a Unique Identifier (UID) for tracking individual parcels. Additionally or alternatively, the shipment information may include product details such as SKU numbers and product names. In some cases, shipment information also includes parcel dimensions measured at the time of shipment. By way of example and with reference to FIGS. 1 and 2, step 408 at least one processor 122 may process the signals from first RFID tag 120A to determine first shipment information while first parcel 112A is located in measurement area 110.

Some embodiments involve communicating with an external server to retrieve additional shipment information when the first shipment information received from an RFID tag attached to the first parcel is incomplete. The external server may be associated with a retailer of the parcel, the sender of the parcel, a shipment company, or a warehouse where the parcel was previously located. Communication with the external server may occur over a communication network, such as network 130. Some passive RFID tags can store anywhere from 64 bits to 8 kilobytes of data. Therefore, in some embodiments, the retrieved additional shipment information may include details not originally stored in the RFID tag. For example, the shipment information determined from the first RFID tag may include an identifier of the first parcel, while the additional shipment information may include the parcel's destination address, parcel dimensions measured at the time of shipment, scheduled delivery time, or handling instructions. In addition, process 400 may involve using artificial intelligence to determine the identity of the external server based on data retrieved from the RFID tag. This computerized process could involve analyzing metadata stored in the RFID tag, such as the manufacturer code or a unique identifier, and cross-referencing this information with a database to predict which external server is likely to have the additional shipment information. The artificial intelligence system may employ machine learning algorithms to recognize patterns and make predictions based on historical data, thereby automating the identification process in a manner that cannot be efficiently implemented by a human.

Other embodiments involve instructing at least one RFID reader to actively search for shipment information. The term “actively search for shipment information” refers to a mode of operation where the RFID reader uses enhanced settings, such as increased power output or altered signal frequencies, to intensively scan for RFID tags. The active searching mode is different from normal scanning, where the RFID reader operates at standard power and frequency levels, passively waiting for tags to come within range. In one implementation, the RFID reader is instructed to actively search for shipment information in response to the detection of movement of RFID tags in the overlapping area. The term “detection of movement of RFID tags in the overlapping area” refers to identifying changes in the location of an RFID tag within a specific zone associated with second capturing area. This movement is typically associated with the movement of the vehicle carrying the parcel and the RFID tag. In another implementation, the RFID reader is instructed to actively search for shipment information in response to receiving a request from an operator of the vehicle. In an example scenario a forklift carrying a parcel may pass through a designated area (e.g., measurement area 110). The driver may receive an indication via a traffic signal apparatus that the shipping information is not obtained. In response, the driver can press a graphical user interface (GUI) element to initiate an active search for shipment information, ensuring that the RFID reader captures the data necessary for determining the shipment information.

Step 410 of process 400 includes making a determination that the first shipment information correlates with the set of dimension-measurements of the first parcel. The term “correlates with” refers to a mutual relationship or connection between two sets of data or information, where first data set received from the sensor is compared to second data set received from the RFID reader to identify common patterns or associations. A processor determines that the first data set correlates with the second data set by applying algorithms that analyze the data from both sets. These algorithms may include statistical methods, pattern recognition techniques, or machine learning models. For example, the processor may apply a trained model to identify corresponding elements or relationships between the first data set and the second data set based on predefined criteria or learned associations. The determination is made when the relationship exceeds a predefined threshold of confidence. In one example, making a determination that the first shipment information correlates with the set of dimension-measurements of the first parcel may involve matching the measured dimensions of a parcel with its shipment details to ensure accuracy. In another example, making a determination that the first shipment information correlates with the set of dimension-measurements of the first parcel may involve comparing time steps and estimated locations of the sources of the first data set and the second data set. By way of example and with reference to FIGS. 1 and 2, step 408 at least one processor 122 may determine that the first shipment information associated with first RFID tag 120A correlates with the set of dimension-measurements determined by sensor 106.

In some embodiments, the determination that the first shipment information correlates with the set of dimension-measurements of the first parcel involves determining that an RFID tag corresponding with the first shipment information recently entered into the second capturing area. For example, when the RFID tag is detected by the RFID reader, it triggers a system update that logs the entry time of first parcel 112A, thereby confirming its presence in the overlapping area 204 at the same time frame that the measurements from sensor 106 are received. In other embodiments, the determination that the first shipment information correlates with the set of dimension-measurements of the first parcel involves verifying that the first shipment information matches a predefined shipment ID format. The term “verifying that the first shipment information matches a predefined shipment ID format” refers to the process of ensuring that the shipment ID adheres to a specific structure or pattern, such as a combination of letters and numbers of a certain length. Verifying that shipment information matches predefined ID formats is preferred as it maintains data integrity, prevents errors by catching typos, prevent fraud or manipulation of shipment details, and enables lowering processor utilization. This verification process may be automated and performed by a computer system using pattern recognition algorithms that scan the shipment ID for compliance with the predefined format. For example, Luhn algorithm and modulo calculations may be used in the verification process. This automated process eliminates the possibility of human error, ensuring accuracy and consistency.

Additional embodiments involve using artificial intelligence and machine learning algorithms to correlate the first shipment information with the set of dimension-measurements and to enhance the accuracy and speed of the association events. A Machine Learning (ML) algorithm is a computational model that uses statistical techniques to enable a system to improve its performance on a specific task through experience. In this context, the machine learning algorithm is trained on historical shipment data, including shipment information and corresponding dimension-measurements. By analyzing patterns and relationships within this data, the algorithm can predict and match new shipment information with the appropriate set of dimension-measurements, enhancing the accuracy and efficiency of the correlation process. Artificial Intelligence (AI) is a branch of computer science focused on creating systems capable of performing tasks that typically require human intelligence. These systems process information, recognize patterns, learn from experience, and make decisions to achieve specific goals. The ML/AI capabilities of RFID system 100 may improve the detection of the single RFID tag associated with the dimension capture event. In one embodiment, RFID system 100 may maintain a list of all the detected RFID tags to eliminate extraneous tags in the measurement area. The ML analysis may be used not only to remove those extraneous RFID reads from the dimension capture event but also to identify when multiple parcels are being moved simultaneously through the measurement area with a single vehicle.

By way of example, some of the ML and AI algorithms used to enhance the accuracy and speed of the association events may include correlating shipment information with a set of dimension measurements using supervised learning algorithms. These algorithms involve training a model on a labeled dataset where the input data is paired with the correct output. The model learns to map inputs to outputs, making it suitable for prediction tasks. A first type of supervised learning algorithm may be linear regression, which can be used to correlate current shipment information with a set of dimension measurements based on past shipment information and dimension measurements. A second type of supervised learning algorithm may be Support Vector Machines (SVM), which is used for classification tasks such as categorizing shipments into different size categories based on their dimensions. For example, by training an SVM model on historical shipment data, the algorithm can classify a new shipment as “small,” “medium,” or “large” based on shipment information, aiding in efficient sorting and handling processes. Additionally, or alternatively, unsupervised learning algorithms may be used to correlate shipment information with a set of dimension measurements. Unsupervised learning algorithms deal with unlabeled data, and the goal of these algorithms is to infer the natural structure present within a set of data points. One type of unsupervised learning algorithm may be K-means clustering, which can be used to group shipments with similar dimension measurements. For example, by applying K-means clustering to historical shipment data, the algorithm can identify clusters of shipments with similar dimensions. Additionally, or alternatively, deep learning algorithms may be used to correlate shipment information with a set of dimension measurements. Deep learning algorithms use neural networks with multiple layers to model complex patterns in data. One type of deep learning algorithm may be Convolutional Neural Networks (CNNs), which can be used for image-based analysis of shipments to determine their dimensions. For example, by training a CNN on images of shipments with known dimensions, the algorithm can automatically analyze new shipment images to extract dimension measurements.

Step 412 of process 400 includes, in response to the determination, updating an inventory management system with data associating the first shipment information with the set of dimension-measurements of the first parcel. The term “updating” refers to the process of modifying or altering existing data within a database. This can involve adding new information, changing existing entries, or deleting outdated or incorrect data. In some embodiments, updating may involve executing a database operation, such as an UPDATE SQL command, to modify records in a table based on specific criteria. The update process may include adjusting attributes of a data entry (e.g., changing a dimensions parameters of a specific parcel) or storing values based on received inputs. For example, updating might involve adding new shipment details to a database. The term “inventory management system” refers to a software or hardware system used to track and manage shipment of parcels. For example, an inventory management system might be used to monitor the flow of parcels through a shipping facility. By way of example and with reference to FIGS. 1 and 2, at least one processor 122 may update inventory management system 124 with data associating the first shipment information with the set of dimension-measurements of first parcel 112A.

In some embodiments, the inventory management system is being updated while the first parcel is being moved by the vehicle. In certain cases, the inventory management system may be hosted on local servers or computers. Depending on the complexity of the update and the speed of the internet connection, updating the inventory management system can take less than 3 seconds. In other words, the inventory management system can be updated while the first parcel is still in measurement area 110. Additional embodiments involve updating work instructions based on the data associating the first shipment information with the set of dimension-measurements of the first parcel. The term “work instructions” refer to detailed guidelines or procedures that direct the tasks and activities of workers or automated systems to ensure consistency and accuracy in operations. For example, updating the work instructions includes providing driving instructions to the vehicle transporting the first parcel. These driving instructions could include specific locations to move the first parcel.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

It is appreciated that the above-described embodiments can be implemented by hardware, or software (program codes), or a combination of hardware and software. If implemented by software, it can be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above-described modules/units can be combined as one module or unit, and each of the above-described modules/units can be further divided into a plurality of sub-modules or sub-units.

The block diagrams in the figures illustrate the architecture, functionality, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as example only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It will be appreciated that the embodiments of the present disclosure are not limited to the exact construction that has been described above and illustrated in the accompanying drawings, and that various modifications and changes may be made without departing from the scope thereof. And other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application. These examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

1. A Radio Frequency Identification )RFID) system for monitoring parcels in a shipping facility, the RFID system comprising:
at least one sensor associated with a first field of view defining a first capturing area, wherein the at least one sensor is configured to capture one or more dimension measurements of parcels being moved by a vehicle through the first capturing area;
at least one RFID reader associated with a second field of view defining a second capturing area that at least partially overlaps with the first capturing area and thereby forms an overlapping area, wherein the at least one RFID reader is configured to retrieve shipment information from RFID tags of parcels in the second capturing area;
at least one processor configured to perform operations to:
receive, from the at least one sensor, a set of dimension-measurements of a first parcel while the first parcel is located in the first capturing area;
receive, from the at least one RFID reader, signals from a first RFID tag of the first parcel and from a group of RFID tags of parcels located outside the overlapping area;
control operations of the at least one RFID reader to limit interference from the group of RFID tags;
process the signals from the first RFID tag to determine first shipment information while the first parcel is located in the overlapping area;
make a determination that the first shipment information corresponds with the set of dimension-measurements of the first parcel; and
in response to the determination, update an inventory management system with data associating the first shipment information with the set of dimension-measurements of the first parcel.

2. The RFID system of claim 1, wherein the at least one sensor includes at least one of a LIDAR sensor, an infrared sensor, an ultrasonic sensor, or a camera-based sensor.

3. The RFID system of claim 1, further comprising a weight sensor configured to measure weight of the first parcel, wherein the data used to update the inventory management system includes the weight of the first parcel.

4. The RFID system of claim 1, wherein the at least one RFID reader includes a plurality of antenna arrays separated from each other.

5. The RFID system of claim 4, wherein a distance between two opposing antenna arrays from the plurality of antennas arrays is greater than 0.5 meter and an angle at which the two opposing antenna arrays intersect is 160 degrees.

6. The RFID system of claim 1, wherein the at least one RFID reader is configured to decode the first shipment information from a passive RFID tag.

7. A method for monitoring parcels in a shipping facility using Radio Frequency Identification (RFID), the method comprising:
receiving, from at least one sensor with a first field of view defining a first capturing area, a set of dimension-measurements of a first parcel while the first parcel is moved by a vehicle through the first capturing area;
receiving, from at least one RFID reader associated with a second field of view defining a second capturing area that at least partially overlaps with the first capturing area and thereby forms an overlapping area, signals from a first RFID tag of the first parcel and from a group of RFID tags of parcels located outside the overlapping area;
controlling operations of the at least one RFID reader to limit interference from the group of RFID tags;
processing the signals from a first RFID tag to determine first shipment information while the first parcel is located in the overlapping area;
making a determination that the first shipment information correlates with the set of dimension-measurements of the first parcel; and
in response to the determination, updating an inventory management system with data associating the first shipment information with the set of dimension-measurements of the first parcel.

8. The method of claim 7, further comprising operating the at least one RFID reader at a reduced power level to limit its read range to areas in the shipping facility beyond the first capturing area.

9. The method of claim 7, wherein the determination that the first shipment information correlates with the set of dimension-measurements of the first parcel involves determining that an RFID tag corresponding with the first shipment information recently entered into the second capturing area.

10. The method of claim 7, wherein the determination that the first shipment information correlates with the set of dimension-measurements of the first parcel involves verifying that the first shipment information matches a predefined shipment ID format.

11. The method of claim 7, further comprising communicating with an external server to retrieve additional shipment information when the first shipment information received from an RFID tag attached to the first parcel is incomplete.

12. The method of claim 7, further comprising: instructing the at least one RFID reader to actively search for shipment information in response to detection of movement of RFID tags in the overlapping area or in response to receiving a request from an operator of the vehicle.

13. The method of claim 7, further comprising: updating work instructions based on the data associating the first shipment information with the set of dimension-measurements of the first parcel.

14. The method of claim 13, wherein updating the work instructions includes providing driving instructions to the vehicle transporting the first parcel.

15. A non-transitory computer readable medium containing instructions that when executed by at least one processor cause the at least one processor to perform operations for monitoring parcels in a shipping facility using Radio Frequency Identification (RFID), the operations comprising:
receiving, from at least one sensor with a first field of view defining a first capturing area, a set of dimension-measurements of a first parcel while the first parcel is moved by a vehicle through the first capturing area;
receiving, from at least one RFID reader associated with a second field of view defining a second capturing area that at least partially overlaps with the first capturing area and thereby forms an overlapping area, signals from a first RFID tag of the first parcel and from a group of RFID tags of parcels located outside the overlapping area;
controlling operations of the at least one RFID reader to limit interference from the group of RFID tags;
processing the signals from a first RFID tag to determine first shipment information while the first parcel is located in the overlapping area;
making a determination that the first shipment information correlates with the set of dimension-measurements of the first parcel; and
in response to the determination, updating an inventory management system with data associating the first shipment information with the set of dimension-measurements of the first parcel.

16. The non-transitory computer readable medium of claim 15, wherein the operations further include outputting an error message when multiple RFID tags are detected in the overlapping area simultaneously.

17. The non-transitory computer readable medium of claim 15, wherein the operations further include filtering out readings from moving RFID tags located outside the overlapping area.

18. The non-transitory computer readable medium of claim 15, wherein the operations further include filtering out readings from static RFID tags located in the overlapping area.

19. The non-transitory computer readable medium of claim 15, wherein the operations further include using a machine learning algorithm to correlate the first shipment information with the set of dimension-measurements.

20. The non-transitory computer readable medium of claim 15, wherein the inventory management system is being updated while the first parcel is being moved by the vehicle.
